(19) United States
(12) Patent Application Publication
(10) Pub. No.: US 2015/0011454 A1
(43) Pub. Date: Jan. 8, 2015

(54) STABLE AQUEOUS NITRIC OXIDE SOLUTIONS, METHODS OF THEIR PREPARATION AND USES THEREOF

(71) Applicant: YISSUM RESEARCH DEVELOPMENT COMPANY OF THE HEBREW UNIVERSITY OF JERUSALEM LTD., JERUSALEM (IL)

(72) Inventors: Yoel Sasson, Jerusalem (IL); Hila Mizrahi, Jerusalem (IL); Assaf Lowenthal, Rishon Lezion (IL); Zach Barnea, Jerusalem (IL)

(21) Appl. No.: 14/369,232

(22) PCT Filed: Dec. 27, 2012
(86) PCT No.: PCT/IL2012/000400

§ 371 Date: Jun. 27, 2014

Related U.S. Application Data
(60) Provisional application No. 61/580,320, filed on Dec. 27, 2011.

(51) Int. Cl. C11D 7/20

(52) U.S. Cl. CPC C11D 7/20
USPC 510/405

(57) ABSTRACT

The invention relates to processes for preparing aqueous nitric oxide solutions, by means of introducing a nitric oxide gas stream into an acidic, halide-containing aqueous solution, or by means of nitrite reduction in an acidic environment in the presence of halide ion. The resultant solutions are stable and can be used for treating surfaces prone to the formation of biofilm, or having biofilm thereon.

Nitric oxide (NO) is a colorless gas which combines readily with oxygen to form the nitrogen dioxide gas, NO₂. The solubility of nitric oxide in water is low (i.e., not more than about 2 mM), and its production in an aqueous form, to give aqueous solutions with stable nitric oxide content meets with considerable difficulties.

Gabor [Microchemical Journal 56, p. 171-176 (1997)] reports that the concentration of nitric oxide in acidic aqueous solutions decreases over time, with the rate of decrease being both temperature and concentration dependent. At room temperature, the NO content of supersaturated acidic aqueous solutions decreases sharply owing to the escape of nitric oxide gas from the aqueous solution. The escape of nitric oxide from undersaturated NO solutions proceeds at a slower rate.

Recently, organic NO donors were proposed for treating biofilms. Biofilms, the matrix-embedded microorganism aggregations adhered to a surface, have been a cause of significant damage in many industrial facilities. For example, membranes employed in processes for water treatment, e.g., in water desalination plants, are particularly prone to develop biofilms.

In view of the instability and inconvenient handling of nitric oxide, it has been proposed in the art to use NO donors, in particular organic NO donors, for biofilm removal. For example, Barraud et al. [Microbial Biotechnology (2009) 2(3), 370-378] describe the use of various nitric oxide donors, such as sodium nitroprusside, S-nitroso-N-acetylpenicillamine, S-nitroso-L-glutathione and disodium 1-[2-(carboxylato)pyrrolidin-1-yl]diazen-1-ium-1,2-diolate, for the removal of biofilms. However, the use of organic compounds as sources of nitric oxide, especially in the water industry, gives rise to environmental issues.

It has now been found that nitric oxide in highly dilute aqueous solutions is stabilized against oxidation in an acidic environment in the presence of halide ion, e.g., in the presence of hydrohalic acid such as hydrochloric acid, and that said highly dilute nitric oxide solutions are useful, inter alia, for biofilm control. The present invention relates to the preparation of highly dilute aqueous nitric oxide solutions, in which the concentration of NO dissolved in the solution is significantly below the saturation limit, i.e., between 0.1 nM and 1 mM, in particular between 0.1 nM and 10,000 nM. The solutions are prepared without the use of organic NO-donors, and are hence suitable for various applications, in particular for the prevention or removal of biofilm formed in various industrial aqueous systems prone to biofouling by microbial species. When put to use for biofilm control, the NO solutions of this invention are normally diluted in an industrial water stream which comes in contact with the biofilm, such that the level of nitric oxide in said water stream is adjusted within the range from 0.001 nM to 1000 nM, preferably from 0.1 nM to 300 nM, thereby effectively removing or inhibiting biofilm formation on surfaces exposed to said water stream.

The invention provides a process for preparing an aqueous nitric oxide solution, comprising introducing a nitric oxide gas stream into an acidic, halide-containing aqueous solution. The invention also provides a process for preparing an aqueous nitric oxide solution, comprising the reduction of nitrite (NO₂⁻) in an acidic environment in the presence of halide, e.g., chloride or bromide ion. Preferably, the pH of the solution is between 0 and 3, more preferably between 0 and 1. When the halide is chloride, then the concentration of the chloride in the solution is preferably not less than 0.12M, more preferably not less than 0.2M, e.g., not less than 0.5M. When the halide is bromide, then the concentration of the bromide in the solution is preferably not less than 0.001M, e.g., from 0.001M to 0.09M. The concentration of NO in the solution of the invention is preferably between 0.1 nM and 10,000 nM.

According to a first embodiment of the invention, nitric oxide is introduced into an acidic, halide-containing aqueous solution by bubbling a dilute nitric oxide gas stream into said solution. The term halide encompasses chloride (Cl⁻), bromide (Br⁻) or iodide (I⁻). To this end, a first gas stream comprising nitric oxide and a second gas stream of an inert gas, e.g., nitrogen, are caused to flow at a first and second flow rates, respectively, and are combined to form a gas mixture which is bubbled into the aqueous solution.

Nitric oxide is generally available commercially as a 0.1-100% mixture in nitrogen. The commercially available nitric oxide gas may be bubbled into the aqueous solution either in a neat form, or following dilution with an inert gas, e.g., nitrogen, prior to the bubbling. The desired degree of dilution is achieved by allowing the commercially available nitric oxide gas and the inert gas to flow separately through two mass flow controllers, combining the gases downstream from the mass flow controllers and bubbling the resultant, diluted nitric oxide gas stream into the acidic, halide-containing aqueous solution.

Suitable dilutions are typically achieved using NO and inert gas flow rates in the ranges of 1 to 10 ml/min and 0.1 to 1.0 l/min, respectively. Upon adjusting the flow rates of the two separate gaseous feed streams prior to their mixing, it is possible to affect the concentration of the nitric oxide in the aqueous solution. To this end, the commercial nitric oxide gaseous stream is generally caused to flow at a rate in the range of 0.1-10 ml/minute, whereas the flow rate of the nitrogen gas which is mixed with the gaseous nitrogen oxide stream is from about 0.1 to 1 L/minute. An increase in the NO flow rate results in a corresponding increase in the NO concentration in the aqueous solution. On the other hand, the greater the N₂/NO dilution ratio, the lower is the NO concentration in the final solution. For a predetermined dilution ratio, it is generally more convenient to supply and mix the two separate gaseous streams at relatively high flow rates, thus producing nitric oxide aqueous solutions with concentrations between 5 nM and 10 μM. The concentration of the aqueous solution of hydrogen halide which is used to absorb the gas can be between 0.001 and 10M, for example between 0.001M and 5M. When hydrochloric acid is used, then its concentration in the solution is not less than 0.12M, more preferably not less than 0.2M, e.g., not less than 0.5M. When hydrobromic acid is used, then its concentration in the solution is not less than 0.001M, e.g., from 0.001M to 0.09M (for example, from 0.001M to 0.01M).

According to a second embodiment, nitric oxide is produced by generating an electric discharge in a medium consisting of a mixture of nitrogen and a suitable amount of oxygen. The method comprises passing an electric current through a gaseous mixture consisting of nitrogen and a suitable amount of oxygen, between two electrodes across which voltage is applied (e.g., of about few kV, for example 5 kV or more), and feeding the resultant nitric oxide into an acidic aqueous solution in which halide ion is present, e.g., into hydrochloric acid.

The method set forth above allows an instantaneous generation of gaseous nitric oxide in-situ at or near a site of an industrial process. The resultant, in-situ formed nitric oxide is bubbled into an acidic, halide-containing aqueous solution, which may be injected shortly thereafter into a suitable point at the industrial process, thus offering an alternative to the storage and handling of commercial nitric oxide cylinders at the industrial plant.

In practice, a feed gas, consisting of a suitably proportioned mixture of nitrogen and oxygen, is caused to flow into an electric discharge generator, i.e., a corona discharge generator, such as those commonly used for the production of ozone. Examples of suitable ozone generators are Fischer Ozonator model 505 or Ozone Solution Ozonator model AC-500.

It was found that the concentration of the oxygen in the binary N₂/O₂ feed gas mixture introduced into the electric discharge generator should preferably be less than 1%, and more preferably in the range from 0.001 to 0.1%, e.g. around 30-70 ppm oxygen. This low oxygen content in the feed gas was found to be sufficient for securing the target nitric oxide level in the aqueous solution, while maintaining non-oxidative environment, preventing the oxidation of the nitric oxide. In view of the fact that acceptable oxygen content in commercially available nitrogen cylinders may be within the range set forth above, it is possible in practice to employ only the commercial nitrogen feed gas. The passage of a virtually neat commercial nitrogen gas through the electrical discharge generator, without any premixing with oxygen, is likely to yield a sufficient amount of nitric oxide.

The feed gas is preferably fed to the corona discharge generator at a flow rate in the range of 0.1-1 L/minute. The magnitude of the electric current applied in the electric discharge generator is typically between 0.1 and ampere and is adjusted to meet the desired NO concentration.

The NO-containing gas which exits the plasma zone is introduced into an aqueous solution comprising hydrogen halide, e.g., hydrochloric, hydrobromic acid or hydroiodic acid. The concentration of the aqueous solution of hydrogen halide which is used to absorb the gas can be between 0.001 and 10M, for example between 0.001M and 5M. When hydrochloric acid is used, then its concentration in the solution is not less than 0.12M, more preferably not less than 0.2M, e.g., not less than 0.5M. When hydrobromic acid is used, then its concentration in the solution is not less than 0.001M, e.g., from 0.001M to 0.09M (0.001M to 0.01M).

According to a third embodiment of the invention, nitric oxide is prepared in situ in an acidic aqueous solution by means of reducing nitrite (NO₂⁻) in the presence of chloride or bromide ion.

The nitrite is provided either in the form of a water-soluble salt, e.g. alkali salt such as sodium nitrite or potassium nitrite, or in an acid form, namely, as nitrous acid (HNO₂).

In the former case, nitrite salt, an acid and chloride or bromide donor are charged sequentially or concurrently into water to form an aqueous solution. It is especially useful to use hydrogen chloride (or hydrogen bromide), which supplies both the acidic environment and releases the chloride/bromide ion in the solution. For example, hydrogen chloride may be bubbled into the solution, or may be used in the form of a concentrated aqueous solution. The reduction of the nitrite in the presence of hydrochloric acid is by the following reaction:

4HCl+2KNO₂→Cl₂+2NO+2H₂O+2KCl

The concentration of the nitrite in the aqueous solution is preferably between 1 μM and 1M, and more preferably between 0.5 and 1 M. The molar ratio nitrite:HX in the solution (X═Cl or Br) is from 100:1 to 1:100, and preferably from 10:1 to 1:10. When hydrochloric acid is used, then its concentration in the solution is not less than 0.12M, more preferably not less than 0.2M, e.g., not less than 0.5M. When hydrobromic acid is used, then its concentration in the solution is not less than 0.001M, e.g., from 0.001M to 0.09M (for example, from 0.001M to 0.01M).

It is also possible to use a non-hydrohalic acid, e.g., sulfuric acid, together with a water soluble chloride or bromide salt, e.g., sodium chloride, thus generating an acidic environment comprising chloride or bromide with the concentrations noted above.

In the case where nitrous acid serves both as the nitrite source and the acid source, then a water soluble chloride or bromide salt should be present in the aqueous solution to secure the stability of the nitric oxide.

The dilute aqueous NO solutions prepared by the methods outlined above comprise nitric oxide at a concentration of 0.1 nM to 10000 nM, more preferably from 5 nM to 1000 nM; halide ion, which is either chloride or bromide, at a concentration which is preferably not less than 0.12 M or not less than 0.001M in the case of chloride or bromide, respectively, with the pH of the solution being between 0 and 3.

According to one embodiment, the solution of the invention comprises hydrochloric acid at a concentration of not less than 0.2M, more preferably not less than 0.5M, supplying both the acidity and halide (chloride). According to another embodiment, the solution of the invention comprises hydrobromic acid at a concentration of not less than 0.001M, e.g., from 0.001M to 0.09M (e.g., 0.001M-0.01M). The exact composition of the solution is designed in order to meet various considerations that are presented below.

The aqueous NO solutions are intended, inter alia, for use in aqueous industrial systems in which the presence of nitric oxide is considered beneficial. To this end, the dilute nitric oxide solution may be prepared at a site of an industrial process in which a water stream is produced or employed. The solutions can be prepared in a suitable reactor, e.g., in a batch or in a tubular plug flow type reactor, and then injected, periodically or continuously, into a suitable point in the industrial process water stream. However, it is also possible to generate the nitric oxide directly in the process water stream. This may be particularly advantageous if the process water stream contains sufficient amounts of nitrite or chloride of natural sources, such that the production of nitric oxide through the chemical method set forth above, namely, nitrite reduction, can be accomplished using available reagents. In such a case, the nitric oxide may be produced directly in the process water stream by introducing thereto only the missing reactants (e.g., adding nitrous acid to the water, in case of chloride-containing process water stream). This embodiment of the invention can therefore be applied, for example, for the prevention of biofilm formation in desalination processes, making use of the availability of chloride salt in brackish or seawater feed streams to be treated.

Thus, according to one embodiment of the invention, the nitric oxide solution is formed at or near the site of an industrial process in which a water stream is employed. The aqueous component of the nitric oxide solution, and optionally also the nitrite or chloride components, are provided by the water stream employed in the industrial process, such that said industrial water stream can be directly transformed into a nitric oxide containing-solution, without the need to prepare and dose a stock solution into the water stream.

Another aspect of the invention is an acidic, halide-containing aqueous solution of nitric oxide, wherein the concentration of the nitric oxide is between 0.1 and 10000 nM, e.g., between 100 and 10000 nM for a stock solution and between 0.1 and 300 nM for a working solution obtained following dilution, with the pH of the solution being between 0 and 3, preferably between 0 and 1 for said stock solution, and in the case where the halide is chloride, then the concentration of the chloride ion is not less than 0.12M, preferably not less than 0.2M, e.g., between 0.2M and 1M, while in the case that the halide is bromide, then the concentration of the bromide ion is not less than 0.001M, e.g., from 0.001M to 0.09M. It was found that the aqueous nitric oxide solutions of the invention, containing hydrohalic acid (hydrochloric or hydrobromic acid), remain stable over at least 10 days when kept in sealed containers under inert atmosphere, without any apparent decrease in nitric oxide concentration. When the acidic, halide-containing solutions provided by the methods of the invention were tested for the stability of the nitric oxide under exposure to air, it was found that the oxidation of nitric oxide is significantly slower than in corresponding solutions in the absence of the hydrohalic acid. The biocidally effective concentration of nitric oxide in water is generally within the picomolar or nanomolar ranges, e.g., between about 0.1 and 300 nM. Thus, the concentration ranges noted above relate both to stock solutions prior to their dilution and also to working solutions or working industrial aqueous streams.

The stable aqueous nitric oxide solutions prepared by the processes of the invention are useful, inter alfa, in combating biofilms on surfaces contacted by water. The aqueous system to be treated by the solutions of the invention can be chosen from the group consisting of water distribution and filtration systems, cooling towers, boiler systems, showers, aquaria, sprinklers, pools, spas, fluid transporting pipelines, storage tanks, food and beverage processing lines, wastewater treatment facilities, or any application prone to biofouling by microbial species. As already mentioned above, when put to use for microbiological control or biofilm eradication, the NO solutions of this invention are normally diluted in the water being treated. However, in some cases it is possible to apply a solution of this invention directly onto a surface infected with biofilm and/or other microbial species, e.g., the internal walls of medical devices.

A particularly important application relates to membrane filtration processes employed in water treatment systems for the removal of inorganic constituents and in particular in desalting brackish water and seawater. Since traditional water treatment methods are not always able to meet the requirements imposed by the drinking water regulations, membrane filtration processes are becoming preferable in such applications, particularly due to their small space requirement and efficient removal of contaminants. In pressure-driven membrane processes the feed stream is fed into a membrane device (e.g., pressure vessel) equipped with membranes that divide the device space into a feed side and a permeate side, and in which a pressure difference across the membranes causes the solvent (usually water) to pass from the feed space to the permeate space. The remaining solution which is now concentrated in the rejected solutes, leaves the feed space of the membrane device as a concentrate stream. Pressure driven membranes processes are classified according to the following categories: microfiltration, ultrafiltration (UF), nanofiltration (NF) and reverse osmosis (RO).

The invention therefore provides a method of treating a surface prone to the formation of biofilm, or having biofilm thereon, comprising applying an acidic, halide-containing aqueous nitric oxide solution onto said surface.

It should be noted that the solution is applied directly onto the surface or diluted in an industrial water stream that comes in contact with said surface. Alternatively, the nitric oxide is provided in an industrial water stream (either by being introduced into the stream in a gaseous form, or chemically generated therein), wherein the nitric oxide in said water stream is stabilized by an acidic, halide-containing environment. The industrial water stream is then brought into contact with the surface or the biofilm-coated surface, for the purpose of preventing the formation of a biofilm, or the removal of the biofilm, respectively.

One preferred mode of controlling biofilm according to the invention is carried out as follows. A stabilized aqueous nitric oxide stock solution is prepared according to any one of the processes described in detail above, namely, by bubbling dilute gaseous nitric oxide into a stabilized aqueous environment, flowing nitric oxide generated by plasma discharge into a stabilized aqueous environment, or by reducing nitrite in a stabilized aqueous environment. The concentration of nitric oxide in the stock solution thus formed is from about 1 to 50,000 nM, and preferably from about 10 to 10000 nM. The concentration of hydrochloric acid in the stock solution is in the range of 0.12-2.0 M, and preferably in the range 0.2-2.0 M. The stock solution can be prepared in situ at the water treatment site or alternatively can be prepared elsewhere beforehand and transported to the water treatment site in a sealed container under inert atmosphere. The nitric oxide stock solution is continuously or periodically injected into the water stream employed in the industrial process and brought into contact with the infected surface, at a flow rate affording a nitric oxide concentration in the water stream of 0.001-1000 nM, and preferably 1-300 nM. Normally it is better to adjust the initial concentration of nitric oxide in the water stream to about a few hundreds nanometers. Despite the decay over time under exposure to air, biocidally effective amounts of not less than 0.1 nM NO remain in the water stream even after one hour of treatment, guaranteeing the efficacy of the treatment.

Another consideration taken into account when putting the solutions of the invention to use relates to the drop in the pH of the industrial water stream as a result of the addition of the acidic NO solution. Experimental results accumulated by the inventors indicate that aqueous streams from different sources (e.g. seawater and wastewater streams) exhibit different pH drop in response to the addition of the solution of the invention. Thus, once an acceptable pH drop is determined for some industrial water stream, the dilution ratio of the NO stock solution is adjusted accordingly, in order to secure that the pH value of the industrial stream is only slightly varied within an acceptable range while still securing biocidally effective amount of nitric oxide in the industrial water stream.

An embodiment of the method of treating a surface prone to the formation of biofilm, or having biofilm thereon, is schematically illustrated in FIG. 8. NO solution is prepared in a suitable reactor by the reduction of nitrite, at a site of an industrial process comprising a water stream that comes in contact with a (potentially) infected surface. A stream of hydrochloric acid solution with a concentration of 0.2-2 M and a stream of potassium nitrite solution with a concentration of 0.001-1 M are separately pumped from two reservoirs (1, 2, respectively) by means of pumps P1 and P2 into a mixing chamber (3), wherein nitrite is reduced to afford nitric oxide. The two feed streams flow at approximately equal rates and the resultant concentration of nitric oxide in the stock solution is, for example, from 100 to 30,000 nM. The mixture is then directed by means of pump P3 through feed line 4 into the industrial water stream 5, at a volumetric flow rate which may vary, for example, between 1 ml/min and 10 L/min. The flow rate of the nitric oxide-containing solution is adjusted with respect to the flow rate of the industrial water stream in order to afford biocidal effective NO levels (in terms of biofilm removal) in the industrial water stream, e.g., from 0.001 to 1000 nM, preferably from 0.1 nM to 300 nM. The adjustment is made by means of NO concentration control system 6 which periodically or continuously measures the NO concentration in feed line 4, through which the NO solution flows. The controller 6 may also modify the flows of the initial HCl and nitrite streams, thereby affecting the amount of NO produced in the mixing chamber 3. The stream of NO solution is injected into the industrial water stream and the two streams are mixed together by means of a static mixture 7. The combined stream 8 is then directed to the surface prone to the formation of biofilm, or having biofilm thereon.

### EXAMPLES

### Methods

All reagents were purchased from Sigma Aldrich. The reagents were of analytical grade and were used without further purification.

The nitric oxide content of the solutions was determined using amiNO 700 (Harvard instruments) sensor for amperometric measurements of nitric oxide. The sensor was calibrated according to the user manual. The measurements were preformed in a chamber that kept temperature stable and minimized electrical noise. Using this setup, a detection limit of 1 nM was achieved.

### Example 1

### Preparation of a Stable Aqueous Nitric Oxide Solution Via Gas Bubbling

A mixture of nitrogen and nitric oxide gases at a ratio of 900:7 was bubbled for a period of 4.5 minutes into a sealed vessel containing 50 mL of 1.0 M aqueous hydrochloric acid. The NO source was a commercial 1% NO gas cylinder (in N₂). The flow rates for the nitrogen and the commercial 1% NO gases were 900 ml/min and 7 ml/min, respectively. The concentration of nitric oxide in the solution thus formed was 360 nm. Subsequently, the aqueous solution was transferred into an open vessel and was stirred under air. The solution was sampled over a period of eight minutes at equal time intervals of one minute, and the concentration of nitric oxide in the aqueous solution was determined.

The above experiment was then repeated under the same conditions, using 50 mL of water in place of aqueous hydrochloric acid.

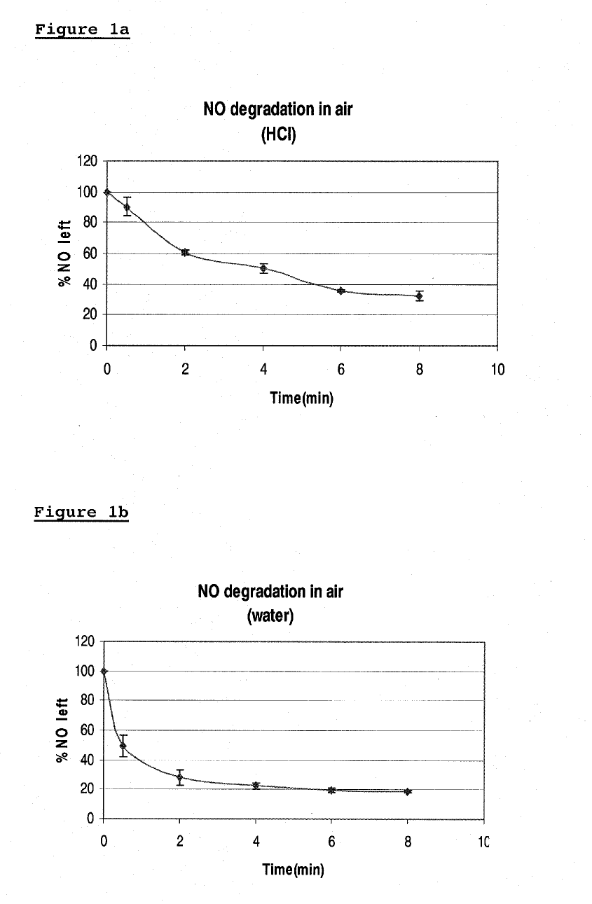

FIGS. 1a and 1b show the variation of the concentration of nitric oxide as a function of time for the experiments carried out in the presence and absence of hydrochloric acid, respectively. In the graphs, the nitric oxide concentration is indicated in terms of percent relative to the initial concentration, where 100% is defined as the nitric oxide concentration at the time the solution was transferred into the open vessel.

It is apparent from FIGS. 1a and 1b that the presence of hydrochloric acid in the aqueous nitric oxide solutions slows down the oxidation of nitric oxide.

### Example 2

### Preparation of a Stable Aqueous Nitric Oxide Solution Via Plasma Discharge

A gaseous mixture consisting of nitrogen and a very small amount of oxygen (50 ppm) was made to flow through a mass flow controller into an ozone generator (Fischer Ozonator model 505) at a rate of 210 mL/minute. The ozone generator was operated at an electric current of 0.11 ampere. The resultant gaseous mixture, which contained nitric oxide, was fed into a sealed vessel containing 50 mL of 1.0 M aqueous hydrochloric acid. The generation of the nitric oxide gas and its flow into the acidic aqueous solution were allowed to continue for an hour, during which period of time the concentration of nitric oxide in the solution was measured periodically.

For comparison, the above experiment was carried out under the same conditions using different concentrations of hydrochloric acid (0.5 M, 0.0 M).

The results are presented in a graphical form in FIG. 2, which shows that nitric oxide can be generated in a gaseous form by means of plasma discharge, and can then be stabilized in an aqueous form in the presence of hydrochloric acid. The concentrations of nitric oxide in the 0.5 M and 1.0 M hydrochloric acid solutions were 75 and 400 nM, respectively. Absent hydrochloric acid, nitric oxide was not detected in the aqueous solution.

### Example 3

### Preparation of a Stable Aqueous Nitric Oxide Solution Via Reduction of Nitrite

Potassium nitrite (KNO₂) was added to aqueous solutions of hydrochloric acid with acid concentrations ranging between 0.0 M and 1.0 M. The concentration of potassium nitrite was 1.0 mM in each of the solutions. The solutions were mixed for ten seconds, following which the concentration of the nitric oxide was determined.

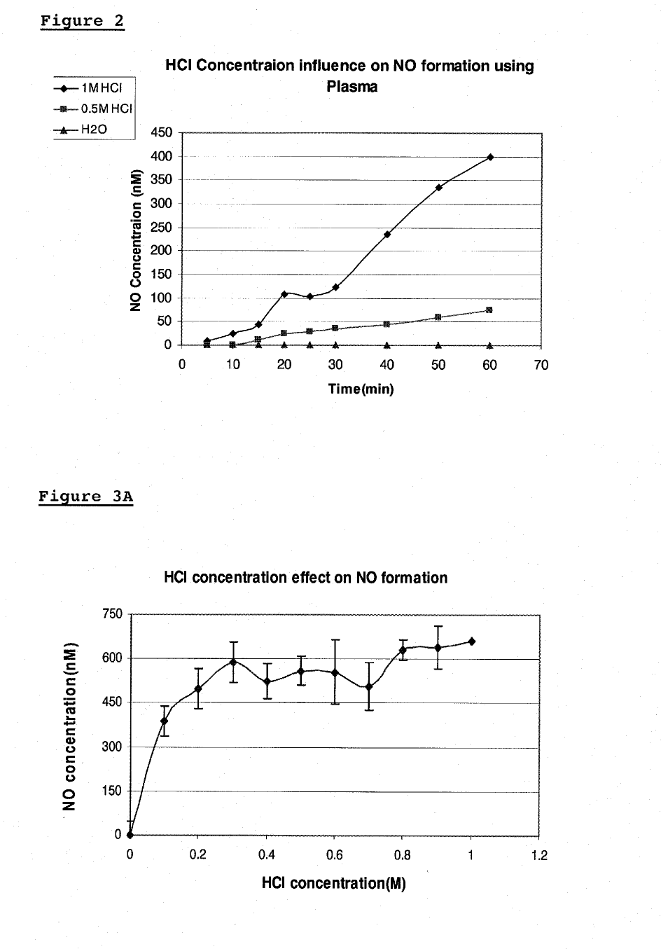

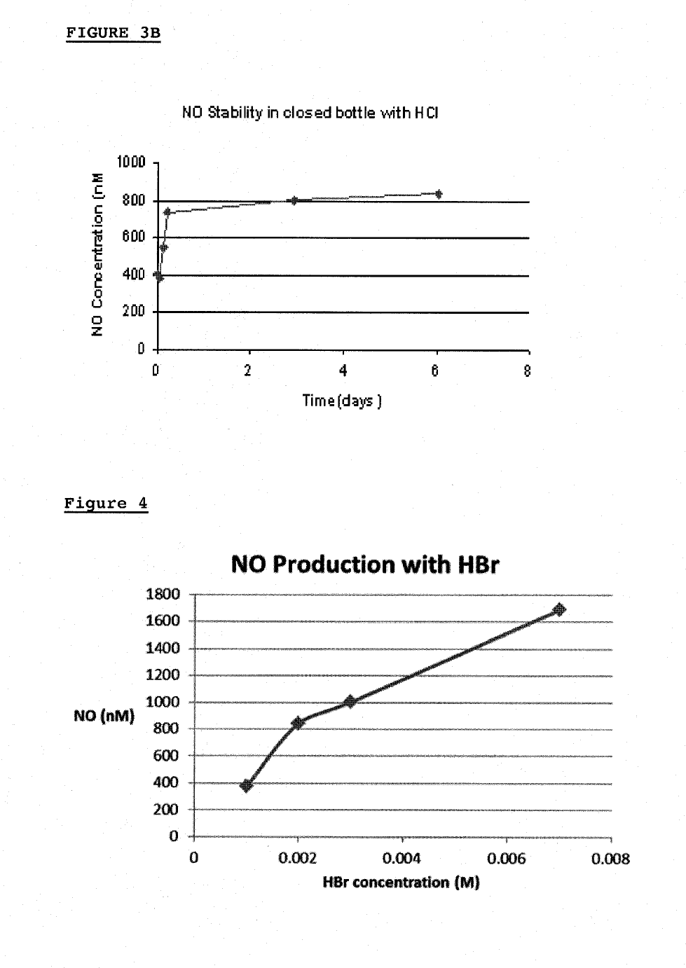

In the graph shown in FIG. 3A, the abscissa indicates the concentration of HCl in the solution, and the ordinate indicates the concentration of nitric oxide formed in the solution.

In the graph shown in FIG. 3B, the NO content in HCl solution is presented as a function of time. The sharp increase in the NO content of the solution observed for the first two days is due to reduction of NO₂⁻, which results in the formation of nitric oxide. In the subsequent days, the NO content of the solution remains essentially constant.

The procedure set out above was repeated, using hydrobrmoic acid in lieu of hydrochloric acid. In the graph shown in FIG. 4, the NO content of the solution is plotted versus the HBr concentration, demonstrating that a workable NO content is achievable when the HBr concentration is relatively low, e.g., from 0.001M to 0.007M.

### Example 4

### Biofilm Removal by Means of Nitric Oxide

In this example, an aqueous solution of nitric oxide, prepared by bubbling nitric oxide gas into a solution of hydrochloric acid, was tested for its activity in relation to the removal of a biofilm.

Preparation of NO Solution

A stock solution of NO was prepared by purging NO gas into 0.1M solution of hydrochloric acid. The NO gas cylinder contained 99% N₂ and 1% NO, and was purged for 10 seconds into a 100 ml sealed serum bottle containing 40 ml HCl solution. The NO concentration detected in the solution was about 5 μM (measured 3 hours after purging, to allow stabilization).

The stock solution was used to prepare a working solution (×100 the final concentration) by diluting (1:9) it into a smaller bottle containing 0.1M hydrochloric acid and very small headspace (<1 ml). The NO concentration in the resultant solution was 140 nM. Finally, a 1 ml gas tight syringe was filled with the solution and was inserted into a syringe pump set to provide a flow rate of 25 μl/min, which is 1% of the flow rate of a second pump delivering filtered waste water, thereby giving 1.4 nM of nitric oxide in the water stream which is to become in contact with the biofilm.

Biofilm Formation and Sampling:

secondary treated waste water was flowed through a Robbins device for two days at laminar flow. Coupons were kept in waste water and brought to the laboratory within six hours.

Treatment:

Four biofilm samples were exposed to the 1.4 nM NO water stream for one hour, while three additional samples were exposed to filtered waste water, but not to nitric oxide. Another sample, designated “fresh sample”, was not introduced to the flow cells and was used for estimation of viability of the biofilm.

Staining and Image Acquisition:

two NO treated samples and one control sample were all stain by BacLight kit (molecular Probes) according to the manufacturer instructions. Image acquisition was done using Leica SP5 CLSM, excitation by 488 nm Argon laser, and emission at 500 to 550 nm for SYTO9 (live), and 600 nm to 660 nm for Propidium Iodide (dead).

Image Processing:

Dead live images were analyzed by both ImageJ and COMSTAT. ImageJ was used for determination of a threshold based on intensity, and for measurement of surface coverage. COMSTAT was used for 3D quantification.

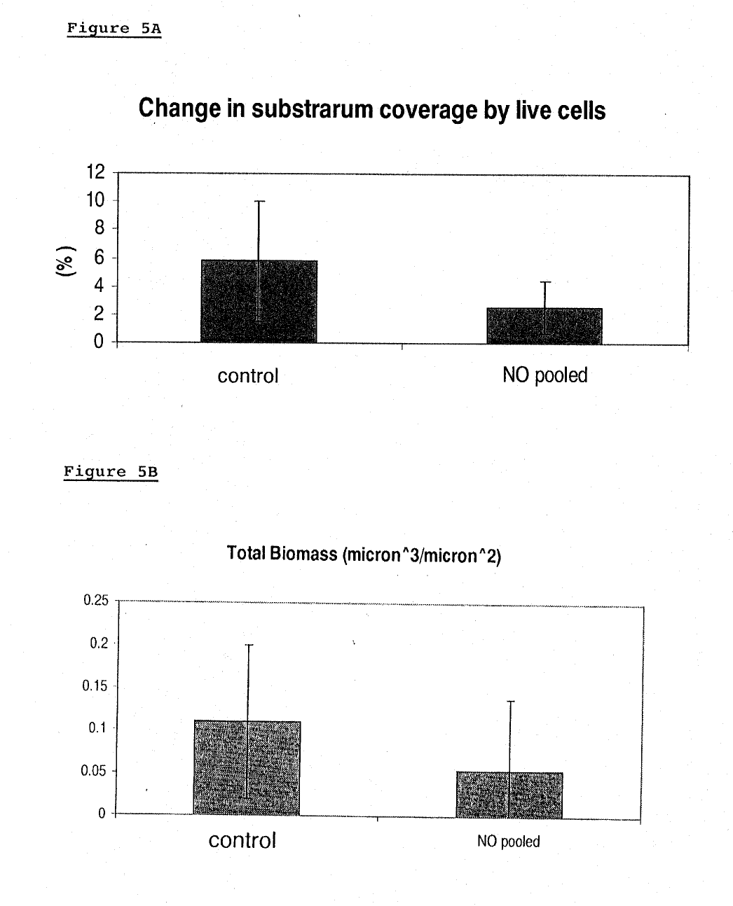

The results are presented in the form of bars diagram in FIGS. 5A and 5B, showing a significant reduction in the percentage of surface coverage by the biofilm (5A) and in the amount of biofilm (5B), for the samples treated with nitric oxide, compared with the untreated samples.

### Example 5

### Biofilm Removal by Means of Nitric Oxide

In this example, an aqueous solution of nitric oxide, prepared by generating nitric oxide gas using an electric discharge process and introducing the gas into a solution of hydrochloric acid, was tested for its activity in relation to the removal of a biofilm.

Preparation of NO and Control Solutions

A stock solution of NO was prepared using the procedure described in Example 2. The concentration of the hydrochloric acid solution used for absorbing the NO gas was 0.1M and the concentration of nitric oxide in the resultant stock solution was about 5.5 μM. Aliquots were taken from the stock solution and diluted with suitable volumes of 0.1M HCl to form three working solutions with different concentrations of nitric oxide: 5.7, 57 and 570 nM. Note that the working solutions are subsequently further diluted, as described below, such that the actual NO concentrations to which the test biofilm was exposed are lower.

For the purpose of comparison, instead of the nitric oxide solution, either a solution of hydrochloric acid at a concentration of 3.4 mM (final concentration to which the biofilm was exposed) or a solution of 6 mg/l nitrate and 1.6 mg/l nitrite were used.

Biofilm Formation and Treatment

biofilms were grown in 96 well microtiter plates as follows. Over night cultures of Pseudomonas aeruginosa diluted ×1000 in M9 medium were incubated at 30° C. with shaking at 100 rpm, allowing biofilm formation on polystyrene wells. After 24 hours the medium was replaced with fresh medium, and 5 μl of aqueous nitric oxide solution was added to 145 μl sample. As a result of this final dilution (1:29), the concentrations of nitric oxide to which the biofilm was exposed were 0.19 nM, 1.9 nM and 19 nM, respectively.

The cells were incubated for another hour. Subsequently, the planktonic phase was transferred to a new plate for quantifying GFP expressing planktonic cells by a fluorometeric plate reader (Biotek instruments, Inc., synergy 2, Exitation at 485 nm, emission at 528 nm). The biofilm cells attached to the surface were then stained for minutes with 0.1% (W/V) of crystal violet, residual crystal violet stain was washed with phosphate buffer, and crystal violet was extracted from attached cells with 100% ethanol. Biofilm formation was quantified spectrometerically using the plate reader mentioned above, this time at OD 600 nm. As control, the above experiment was carried out under the same conditions without the introduction of nitric oxide into the polystyrene wells.

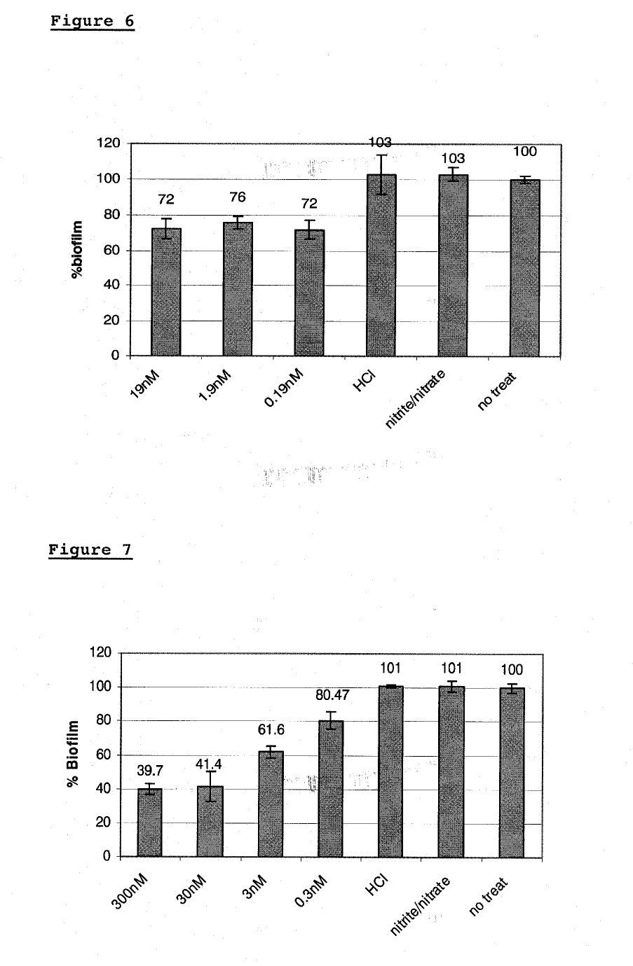

The results are presented in the form of a bar diagram in FIG. 6. It is apparent that the amount of biofilm in the samples treated with nitric oxide is significantly lower than in the three control samples, i.e. about 28% difference. The efficacy of the nitric oxide solution in biofilm removal is comparable for the three different concentrations tested (0.19 nM, 1.9 nM and 19 nM).

### Example 6

### Biofilm Removal by Means of Nitric Oxide

In this example, an aqueous solution of nitric oxide, prepared by reducing nitrite in a solution of hydrochloric acid, was tested for its activity in relation to the removal of a biofilm.

Preparation of NO Solution

A stock solution of NO was prepared using the procedure described in Example 3. Briefly, a solution of potassium nitrite at a concentration of 1 mM was mixed with an equal volume of 0.2 M HCl solution. The concentration of nitric oxide in the resultant stock solution was about 8700 nM. Aliquots were taken from the stock solution and diluted with suitable volumes of 0.1 M HCl to form two working solution with the following concentrations of nitric oxide: 870 nM and 87 nM. The third working solution was the stock solution itself. Note that the three solutions are subsequently further diluted, as described below, such that the actual NO concentrations to which the test biofilm was exposed are lower.

For the purpose of comparison, instead of the nitric oxide solutions, either a solution of hydrochloric acid at a concentration of 3.4 mM (a final concentration to which the biofilm was exposed), or solutions of 6 mg/l nitrate and 1.6 mg/l nitrite were used.

Biofilm Formation and Treatment

biofilms were grown and treated according to the procedure described in Example 5. In view of the 1:29 dilution factor, the concentrations of nitric oxide to which the biofilm was exposed were 3 nM, 30 nM and 300 nM.

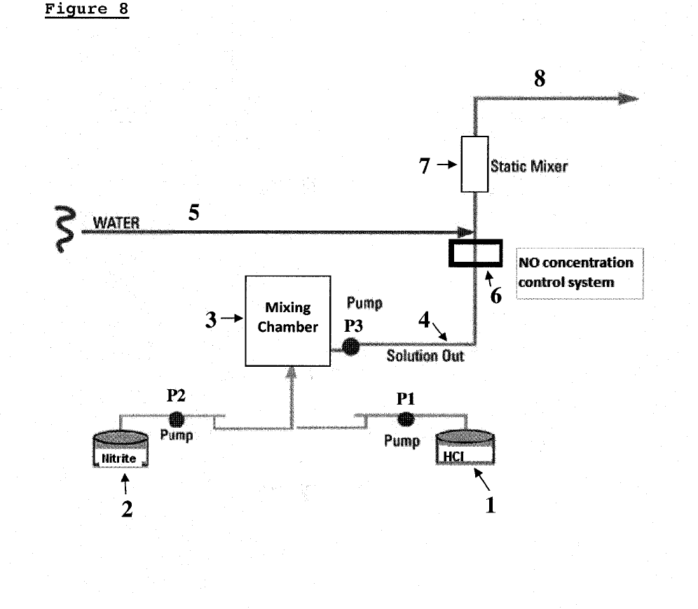

The results are depicted in FIG. 7. It is apparent that the amount of biofilm in the samples treated with nitric oxide is significantly lower in comparison with the three control samples. The reduction of biofilm in the sample treated with the highest nitric oxide concentration, i.e. 300 nM, was over 60%.

1. A process for preparing an aqueous nitric oxide solution, comprising introducing a nitric oxide gas stream into an acidic, halide-containing aqueous solution.

2. A process according to claim 1, wherein the nitric oxide gas stream is diluted prior to the introduction into the solution by combining a first gas stream comprising nitric oxide with a second, inert gas stream.

3. A process according to claim 1, wherein the nitric oxide gas stream is generated by passing an electric current through a gaseous mixture consisting of nitrogen and a suitable amount of oxygen, between two electrodes across which voltage is applied.

4. A process according to claim 1, wherein the concentration of the nitric oxide in the solution is between 0.1 nM and 10000 nM, the halide is chloride, the concentration of which is not less than 0.12M, with the pH of the solution being between 0 and 3.

5. A process for preparing an aqueous nitric oxide solution, comprising the reduction of nitrite (N02-) in an acidic environment in the presence of chloride ion to form a solution with nitric oxide concentration between 0.1 nM and 10000 nM, wherein the chloride concentration is not less than 0.12M, with the pH of the solution being between 0 and 3.

6. A process according to claim 4, wherein the concentration of the chloride is not less than 0.2M.

7. A process according to claim 1, wherein hydrochloric acid is used to form the acidic, chloride-containing aqueous solution.

8. A process for preparing an aqueous nitric oxide solution, comprising the reduction of nitrite (N02-) in an acidic environment in the presence of bromide ion to form a solution with nitric oxide concentration between 0.1 nM and 10000 nM, wherein the bromide concentration is not less than 0.001M, with the pH of the solution being between 0 and 3.

9. A process according to claim 8, wherein the concentration of the bromide is from 0.001M to 0.09M.

10. A process according to claim 1, wherein the nitric oxide solution is formed at or near the site of an industrial process employing a water stream, wherein the aqueous component of the nitric oxide solution, and optionally also the nitrite or chloride components, are provided by the industrial water stream, such that said industrial water stream is transformed into the nitric oxide containing-solution.

11. An acidic, chloride-containing aqueous solution of nitric oxide, wherein the concentration of the nitric oxide is between 0.1 nM and 10000 nM, the pH of the solution is between 0 and 3 and the concentration of the chloride ion is not less than 0.12M.

12. An acidic, chloride-containing aqueous solution of nitric oxide according to claim 11, wherein the concentration of the chloride is not less than 0.2M.

13. An acidic, bromide-containing aqueous solution of nitric oxide, wherein the concentration of the nitric oxide is between 0.1 nM and 10000 nM, the pH of the solution is between 0 and 3 and the concentration of the bromide ion is not less than 0.001M.

14. An acidic, bromide-containing aqueous solution of nitric oxide according to claim 13, wherein the concentration of the bromide is from 0.001M to 0.09M.

15. A method of treating a surface prone to the formation of biofilm, or having biofilm thereon, comprising applying an acidic, halide-containing aqueous nitric oxide solution onto said surface.

16. A method according to claim 15, wherein the solution is applied directly onto the surface or introduced into a water stream that comes in contact with said surface.

17. A method according to claim 16, wherein the nitric oxide is provided in an industrial water stream and wherein the nitric oxide in said water stream is stabilized by an acidic, halide-containing environment.
